(19) United States
(12) Patent Application Publication
(10) Pub. No.: US 2012/0066293 A1
(43) Pub. Date: Mar. 15, 2012

(54) DATA RELAY SYSTEM, RELAY DEVICE, AND COMPUTER READABLE MEDIUM

(75) Inventor: Mai NAKAGAWA, Kanagawa (JP)

(73) Assignee: FUJI XEROX CO., LTD., Tokyo (JP)

(21) Appl. No.: 13/014,934

(22) Filed: Jan. 27, 2011

(30) Foreign Application Priority Data
Sep. 9, 2010 (JP) 2010-202415

(51) Int. Cl. G06F 15/16

(52) U.S. Cl. 709/203

(57) ABSTRACT

According to an aspect of the invention, a data relay system includes: a plurality of server devices which manages data transmitted and received by a client device; and a relay device which relays communication between the client device and each of the plurality of server devices. Each of the plurality of server devices includes: a data storage unit that stores data and a request processing unit that performs processing corresponding to a received request. The relay device includes: a synchronization unit that synchronizes the data in the data storage unit of each of the plurality of server devices; an identification information registration unit that acquires identification information, and a relay processing unit that performs relay processing of receiving a request sent to the server devices by the client device.

### CROSS-REFERENCE TO RELATED APPLICATION

This application is based on and claims priority under 35 USC 119 from Japanese Patent Application No. 2010-202415 filed on Sep. 9, 2010.

### BACKGROUND

1. Technical Field

The present invention relates to a data relay system, a relay device, and a computer readable medium.

2. Related Art

There is a technique of improving the system availability by multiplexing a server in a system including a server which manages transmission and reception of the data between clients.

### SUMMARY

According to an aspect of the invention, a data relay system includes:

a plurality of server devices which manages data transmitted and received by a client device; and

a relay device which relays communication between the client device and each of the plurality of server devices,

wherein each of the plurality of server devices includes:

a data storage unit that stores data, which is addressed to a user of the client device, and identification information, which is given to the data by the server device, so as to match each other; and

a request processing unit that performs processing corresponding to a received request when a request for processing regarding the data stored in the data storage unit is received and transmitting a response including a result of the processing to a request source,

the relay device includes:

a synchronization unit that synchronizes the data in the data storage unit of each of the plurality of server devices by storing the data addressed to the user in the data storage unit of each of the plurality of server devices;

an identification information registration unit that acquires identification information, which is given by each server device for the data stored in the data storage unit of each server device by the synchronization unit, from each server device and registering identification information for a server, which is the acquired identification information, and identification information for a client, which is transmitted to the client device as identification information of the data, in an identification information storage unit so as to match each other; and

a relay processing unit that performs relay processing of receiving a request sent to the server devices by the client device and transmitting the request to one of the plurality of server devices and of receiving a response, which is transmitted in response to the request by the request processing unit of the server device that has received the request, and transmitting the response to the client device, and

when the response includes the identification information for a server, the relay processing unit replaces the identification information for a server included in the response with the identification information for a client, which is stored in the identification information storage unit so as to be matched to the identification information for a server, and then transmits the response to the client device.

### BRIEF DESCRIPTION OF THE DRAWINGS

Exemplary embodiments of the invention will be described in detail based on the following figures, wherein:

FIG. 1 is a block diagram showing an example of the schematic configuration of a system;

FIG. 2 is a block diagram showing an example of the schematic internal configuration of a mail server;

FIG. 3 is a view showing an example of a mail account table;

FIG. 4 is a block diagram showing an example of the schematic internal configuration of an electronic mail proxy device;

FIG. 5 is a view showing an example of the content of a UIDL table;

FIG. 6 is a sequence diagram showing an example of the operations of an electronic mail proxy device and a mail server when a mail server is added to a system;

FIGS. 7A and 7B are views showing examples of the content of a UIDL table at a certain point in time in the sequence shown in the example of FIG. 6;

FIG. 8 is a view showing another example of the content of a UIDL table;

FIG. 9 is a sequence diagram showing an example of the operation of a system when a client terminal receives an electronic mail according to POP;

FIG. 10 is a sequence diagram showing another example of the operation of a system when a client terminal receives an electronic mail according to POP;

FIG. 11 is a sequence diagram showing an example of the operation executed subsequent to the sequence shown in the example of FIG. 10;

FIG. 12 is a sequence diagram showing an example of the operation of a system when a client terminal transmits an electronic mail according to an SMTP; and

FIG. 13 is a block diagram showing an example of the hardware configuration of a computer.

### DETAILED DESCRIPTION

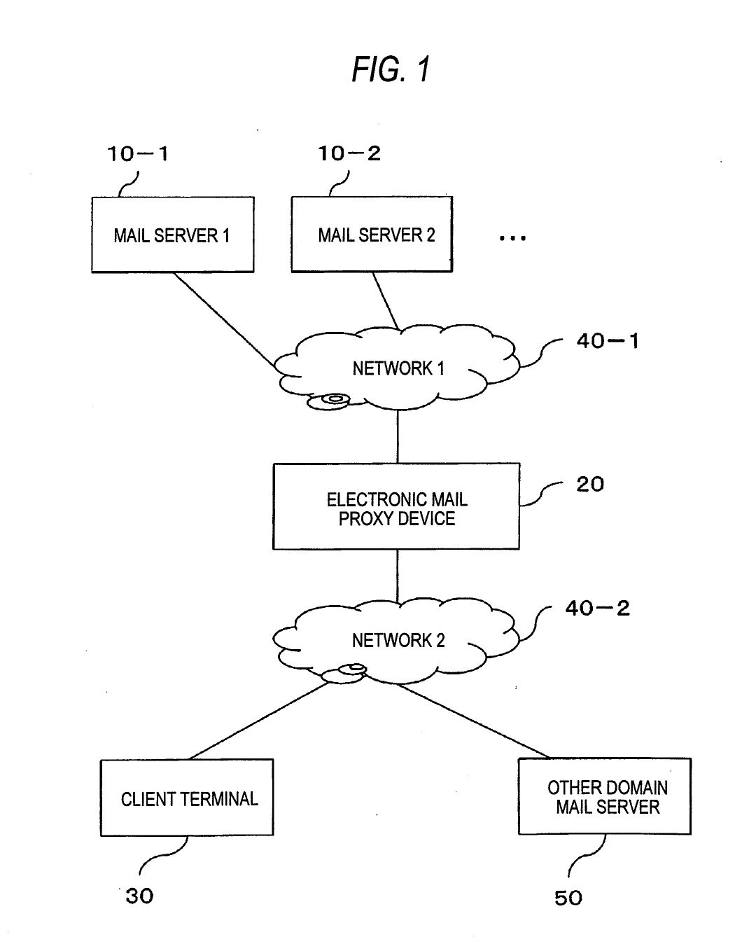

A system illustrated in FIG. 1 has a configuration in which plural of mail servers 10-1, 10-2, . . . are connected to an electronic mail proxy device 20 through a network 40-1 and a client terminal 30 is connected to the electronic mail proxy device 20 through a network 40-2. In addition, another domain mail server 50 is also connected to the network 40-2.

Each of the mail servers 10-1, 10-2, . . . is a server device which manages transmission and reception of electronic mail by mail address including the same domain name. The mail servers 10-1, 10-2, . . . have the same function. In the following explanation, the mail servers 10-1, 10-2, . . . are collectively called a mail server 10 when it is not necessary to distinguish them. Moreover, in the following explanation, the mail servers 10-1, 10-2, . . . may also be called as a mail server 1, a mail server 2, and the like when it is necessary to distinguish them. Details of the mail server 10 will be described later.

The electronic mail proxy device 20 relays communication between each of the mail servers 10-1, 10-2, . . . and the client terminal 30 or the other domain mail server 50. The electronic mail proxy device 20 functions as a relay device in an example of an exemplary embodiment of the invention. The client terminal 30 and the other domain mail server 50 communicate with the mail server 10 through the electronic mail proxy device 20. Details of the electronic mail proxy device 20 will be described later.

The client terminal 30 is a terminal device which performs transmission and reception of electronic mail. The client terminal 30 may be an information processing apparatus, such as a personal computer or a mobile information terminal.

The networks 40-1 and 40-2 are communication means for making communication between apparatuses possible. For example, it is preferable that the network 40-1 is set as a network, such as a LAN (local area network) to which only a specific apparatus is connected, and the network 40-2 is set as a network, such as the Internet to which unspecified apparatuses may be connected. In addition, although the networks 40-1 and 40-2 are different networks in the example shown in FIG. 1, the networks 40-1 and 40-2 may be the same network in an example of another system. Also in the case where the networks 40-1 and 40-2 are set as the same network, the system is designed so that communication between the mail server 10 and other apparatuses is performed through the electronic mail proxy device 20.

The other domain mail server 50 is a server which manages transmission and reception of electronic mail using a mail address including a different domain name from a domain name managed by the mail server 10.

In FIG. 1, only one client terminal 30 and one other domain mail server 50 are shown. However, plural of client terminals 30 and other domain mail servers 50 may be connected to the network 40-2. In addition, the client terminal 30 may be connected not only to the network 40-2 but also to the network 40-1. Also in the case where the client terminal 30 is connected to the network 40-1, communication between the client terminal 30 and the mail server 10 is performed through the electronic mail proxy device 20.

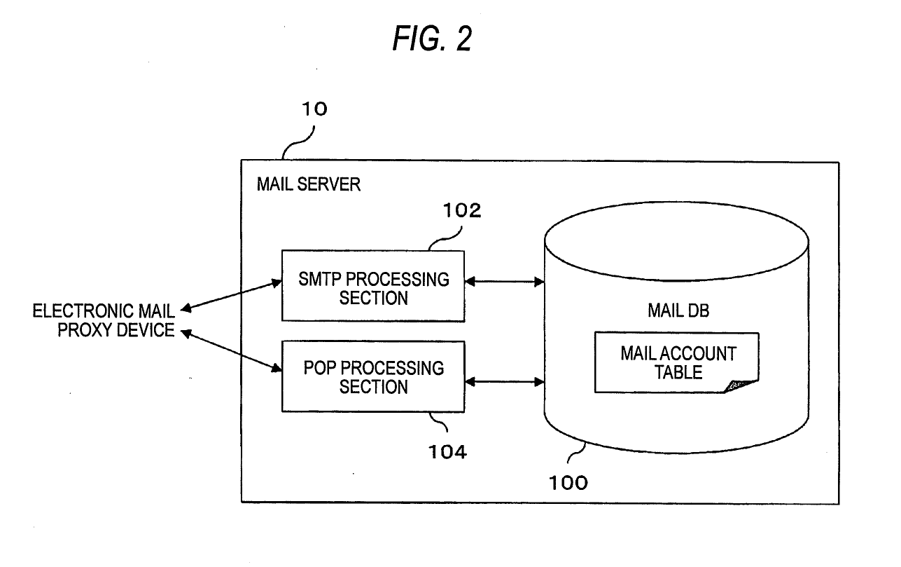

An example of the configuration of the mail server 10 will be described with reference to FIG. 2. The mail server 10 includes a mail DB (database) 100, an SMTP processing section 102, and a POP (Post Office Protocol) processing section 104.

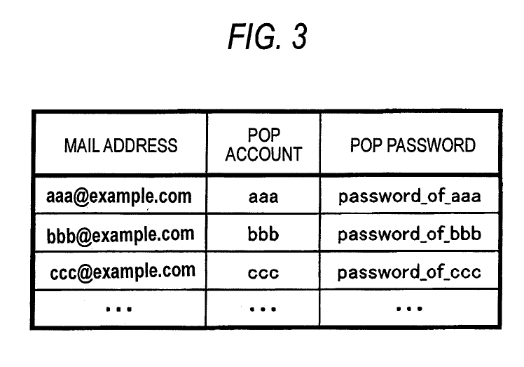

The mail DB 100 is a storage means for storing an electronic mail addressed to a mail address managed by the mail server 10. In addition, the mail DB 100 stores a mail account table which is an information table in which a user account of each mail address managed by the mail server 10 is registered. FIG. 3 shows an example of the mail account table.

In a table shown in the example of FIG. 3, POP accounts and POP passwords of users of corresponding mail addresses are registered so as to match the mail addresses. The mail addresses illustrated in FIG. 3 include the same domain name “example.com”. The POP account is an account used for user authentication when the client terminal 30 communicates with the mail server 10 according to POP. The POP is one of the communication protocols generally used when a client receives electronic mail from a server which manages electronic mail (refer to RFC 1939 and the like). In the example of the present exemplary embodiment, the client terminal 30 receives an electronic mail from the mail server 10 through the electronic mail proxy device 20 according to the POP (which will be described in detail later). The POP password is a password corresponding to the POP account. The mail server 10 responds to the request from the client terminal 30 according to the POP only when authentication based on a set of POP account and POP password succeeds.

The mail DB 100 may further store an SMTP account and an SMTP password in addition to the items illustrated in FIG. 3. The SMTP (Simple Mail Transfer Protocol) is one of the communication protocols generally used in communication between a client and a server and communication between servers when sending an electronic mail (refer to RFC 5321 and the like). In the example of the present exemplary embodiment, the client terminal 30 requests the mail server 10 to send an electronic mail through the electronic mail proxy device 20 according to the SMTP (which will be described in detail later). In this example, since user authentication is not performed in transmission of an electronic mail according to the SMTP, an SMTP account and an SMTP password are not stored in the mail DB 100. In an example where user authentication is performed before starting communication according to the SMTP, an SMTP account and an SMTP password are stored in the mail DB 100 so as to match each electronic mail address and the mail server 10 responds to the request from the client terminal 30 according to the SMTP only when user authentication based on a set of the SMTP account and the SMTP password succeeds.

Referring back to FIG. 2, for every mail address registered in the mail account table, the mail DB 100 stores an electronic mail addressed to the mail address. The identification information called a UIDL (Unique ID Listing) is given to each electronic mail item by the POP processing section 104, which will be described later. The mail DB 100 stores each electronic mail item and a UIDL of the electronic mail so as to match each other.

The SMTP processing section 102 performs processing regarding the communication according to the SMTP. For example, if the mail server 10 receives a request according to the SMTP (hereinafter, also called an “SMTP request”), processing according to the SMTP request is performed by the SMTP processing section 102. For example, if it is an SMTP request regarding electronic mail transmission, the SMTP processing section 102 checks the destination address of an electronic mail to be transmitted first. If the destination address is a mail address registered in the mail account table of the mail DB 100, the electronic mail to be transmitted is stored in the mail DB 100 as an electronic mail addressed to the mail address. In addition, if the destination address is not a mail address registered in the mail account table of the mail DB 100, the electronic mail to be transmitted is sent to the other domain mail server 50 corresponding to the domain name included in the destination address.

The POP processing section 104 performs processing regarding the communication according to the POP. For example, the POP processing section 104 gives a UIDL, which is used as identification information of each electronic mail item from an apparatus which sends a request according to the POP (hereinafter, also called a “POP request”), to each electronic mail item that the SMTP processing section 102 stores in the mail DB 100 as described above. Moreover, if the POP request is received, the POP processing section 104 performs authentication of a user of the request source using a POP account and a POP password registered in the mail account table of the mail DB 100. If the user authentication succeeds, the POP processing section 104 performs processing according to the POP request. For example, in response to a POP request which inquires about the UIDL of an electronic mail addressed to the authenticated user's mail address, the POP processing section 104 sends a UIDL given to each electronic mail, which is addressed to the mail address, to the request source. Details of processing corresponding to other examples of the POP request will be described later. In addition, if the user authentication based on a POP account and a POP password fails, the POP processing section 104 does not perform processing according to the POP request.

The contents of mail account tables and electronic mail stored in the mail DB 100 of the plurality of mail servers 10-1, 10-2, . . . are managed by the electronic mail proxy device 20 so that they are equal. That is, a mail account table with the same content is stored in the mail DB 100 of each of the electronic mail servers 10-1, 10-2, . . . . In addition, synchronization of the data content of the mail DB 100 is performed so that an electronic mail addressed to each mail address of the mail DB 100 of each of the mail servers 10-1, 10-2, . . . becomes the same. In this case, in each of the plurality of mail servers 10, the POP processing section 104 may give different UIDLs to the same electronic mail. That is, UIDLs which are equally stored in the mail DBs 100 of the mail servers 10-1, 10-2, . . . and which are given to a certain electronic mail by the mail servers 10-1, 10-2, . . . may be different.

Moreover, in the plurality of mail servers 10, the specific data structure of the mail DB 100 or software for realizing the SMTP processing section 102 and the POP processing section 104 may be different. For example, the mail DBs 100 of the plurality of mail servers 10 may be realized by different file systems. In addition, for example, operating systems of the plurality of mail servers 10 may be different from each other, or software for realizing the SMTP processing section 102 and the POP processing section 104 may be different between the plurality of mail servers 10 operating in the same operating system.

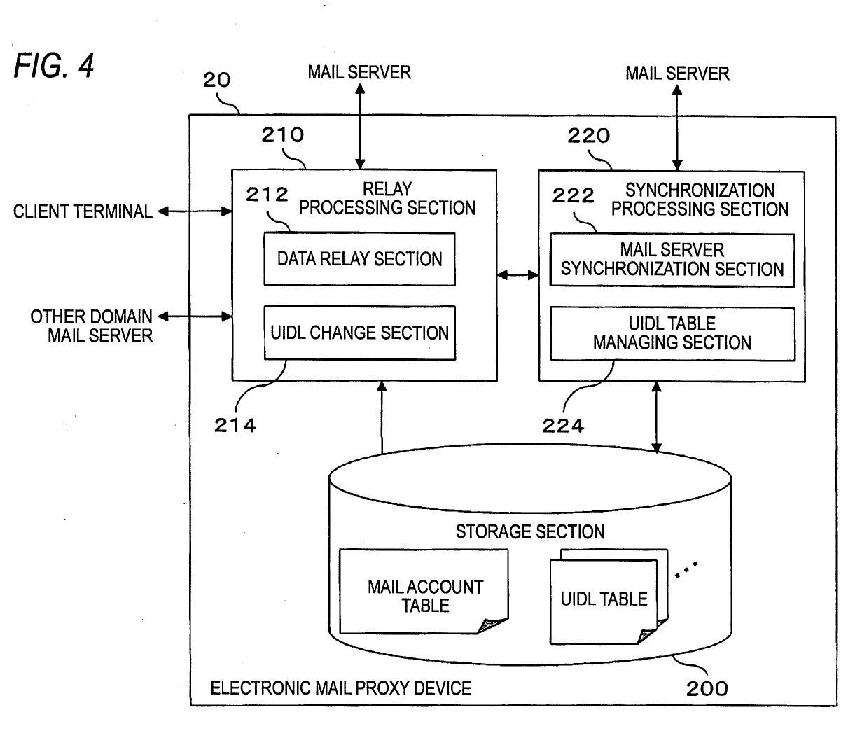

Referring to FIG. 4, an example of the configuration of the electronic mail proxy device 20 will be described. The electronic mail proxy device 20 includes a storage section 200, a relay processing section 210, and a synchronization processing section 220.

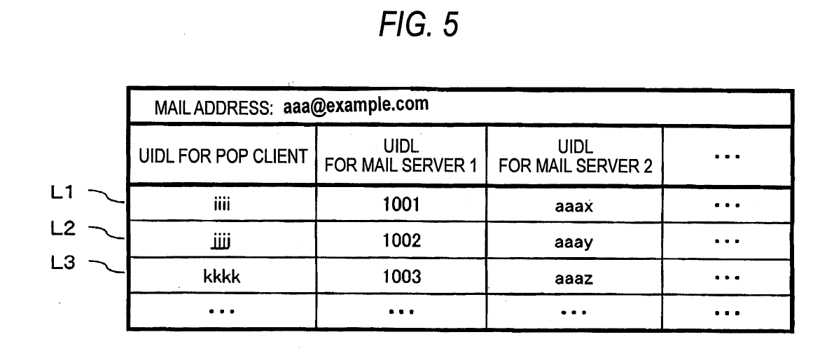

The storage section 200 stores a mail account table and a UIDL table. The content of the mail account table stored in the storage section 200 is the same as the content of the mail account table stored in the mail DB 100 of each mail server 10. For example, when the mail account table shown in the example of FIG. 3 is stored in the mail DB 100 of each mail server 10, the mail account table shown in the example of FIG. 3 is also stored in the storage section 200. The UIDL table is an information table which matches each UIDL, which is given to the same electronic mail by each mail server 10, to a UIDL notified to the client terminal 30 as a UIDL of the electronic mail. FIG. 5 shows an example of a UIDL table.

The table shown in the example of FIG. 5 indicates UIDLs given to electronic mail addressed to a mail address “aaa@example.com”. The first line in the table shown in the example of FIG. 5 indicates UIDLs given to one electronic mail item. In the table shown in the example of FIG. 5, “UIDL for a POP client” indicates a UIDL notified to the client terminal 30 as a UIDL of the electronic mail. The UIDL for a POP client of each electronic mail item is given by the electronic mail proxy device 20. A “UIDL for the mail server 1” and a “UIDL for the mail server 2” indicate UIDLs given to corresponding electronic mail items by the mail servers 10-1 and 10-2, respectively. For example, to an electronic mail corresponding to the line L1 in the table shown in the example of FIG. 5, a UIDL for a POP client “iiii” is given by the electronic mail proxy device 20, a UIDL “1001” is given by the mail server 1, and a UIDL “aaax” is given by the mail server 2.

The electronic mail proxy device 20 in the example of the present exemplary embodiment creates a UIDL table like the example shown in FIG. 5 for every mail address registered in the mail account table and stores it in the storage section 200. An example of the procedure of creating the UIDL table will be described later.

Referring back to FIG. 4, the relay processing section 210 performs processing for relaying communication between the mail server 10 and other apparatuses. The relay processing section 210 includes a data relay section 212 and a UIDL change section 214.

The data relay section 212 receives the data transmitted from the client terminal 30 or the other domain mail server 50 to the mail server 10 and transmits the received data to one of the plurality of mail servers 10. In addition, the data relay section 212 receives the data transmitted from the mail server 10 to the client terminal 30 or the other domain mail server 50 and transmits the received data to an apparatus of the transmission destination. For example, when a request according to the POP or SMTP is received from the client terminal 30, the data relay section 212 transmits the request to one of the plurality of mail servers 10 and transmits a response, which is returned from the one mail server 10 according to the request, to the client terminal 30 of the request source.

When a UIDL for the mail server 10 is included in the data transmitted from the mail server 10 to the client terminal 30, the UIDL change section 214 acquires a UIDL for a client matched to the UIDL for the mail server 10 referring to the UIDL table stored in the storage section 200. Then, the UIDL change section 214 replaces the UIDL for the mail server 10, which is included in the data transmitted from the mail server 10 to the client terminal 30, with a UIDL for a client acquired from the UIDL table and then transmits the data to the client terminal 30.

In the example of the present exemplary embodiment, when the request transmitted to the mail server 10 through the data relay section 212 is a request for processing of changing the data content of the mail DB 100, the relay processing section 210 notifies the situation to the synchronization processing section 220. For example, in the case of an SMTP request to transmit an electronic mail to a mail address managed by the mail server 10, a change occurs in the data content of the mail DB 100 since the electronic mail to be transmitted is newly stored in the mail DB 100 of the mail server 10. Moreover, for example, in the case of a POP request to delete a certain electronic mail from the mail server 10, a change occurs in the data content of the mail DB 100 since the electronic mail is deleted from the mail DB 100 of the mail server 10. When transmitting such requests as in these examples to one of the plurality of mail servers 10, the relay processing section 210 notifies this to the synchronization processing section 220.

The synchronization processing section 220 performs processing for synchronizing the data content of the mail DBs 100 of the plurality of mail servers 10. The synchronization processing section 220 starts the processing for synchronization according to the above-described notification from the relay processing section 210. The synchronization processing section 220 includes a mail server synchronization section 222 and a UIDL table managing section 224.

The mail server synchronization section 222 performs processing for synchronizing the data content of the mail DB 100 provided in each mail server 10. For example, when the above-described SMTP request for electronic mail transmission is transmitted to one of the mail servers 10 and a new electronic mail is stored in the mail DB 100 of the mail server 10, the mail server synchronization section 222 sends a POP request to acquire the new electronic mail from the mail server 10 and sends an SMTP request to each of the other mail servers 10 to store the new electronic mail in the mail DB 100. In addition, for example, when the above-described POP request for electronic mail deletion is transmitted to one of the mail servers 10, the mail server synchronization section 222 sends a POP request to the other mail servers 10 so that the electronic mail to be deleted according to the POP request is also deleted in the mail DB 100 of each of the other mail servers 10.

The UIDL table managing section 224 creates and updates a UIDL table. The UIDL table managing section 224 acquires a UIDL of an electronic mail related to a change of the data content of the mail DB 100 provided in each mail server 10 and updates a UIDL table in the storage section 200. For example, when a new electronic mail is stored in the mail DB 100 of each mail server 10 by the mail server synchronization section 222 in the example of the SMTP request, the UIDL table managing section 224 acquires a UIDL given to the new electronic mail in each mail server 10 from each mail server 10. In addition, each UIDL acquired is registered in a UIDL table by matching a UIDL for a mail server to a UIDL for a client given to the new electronic mail. Moreover, for example, in the case of the above-described POP request for electronic mail deletion, a UIDL that each mail server 10 has given to the electronic mail to be deleted is acquired from each mail server 10 and an information record including each UIDL acquired is deleted from the UIDL table. In addition, after the electronic mail is deleted from each mail server 10 in response to the POP request for electronic mail deletion, the information record corresponding to the electronic mail to be deleted does not necessarily have to be deleted from the UIDL table.

Until now, the example of the configuration of the system in the example shown in FIG. 1 has been described. Hereinafter, an example of the operation of the system shown in the example of FIG. 1 will be described.

[Addition of a Mail Server]

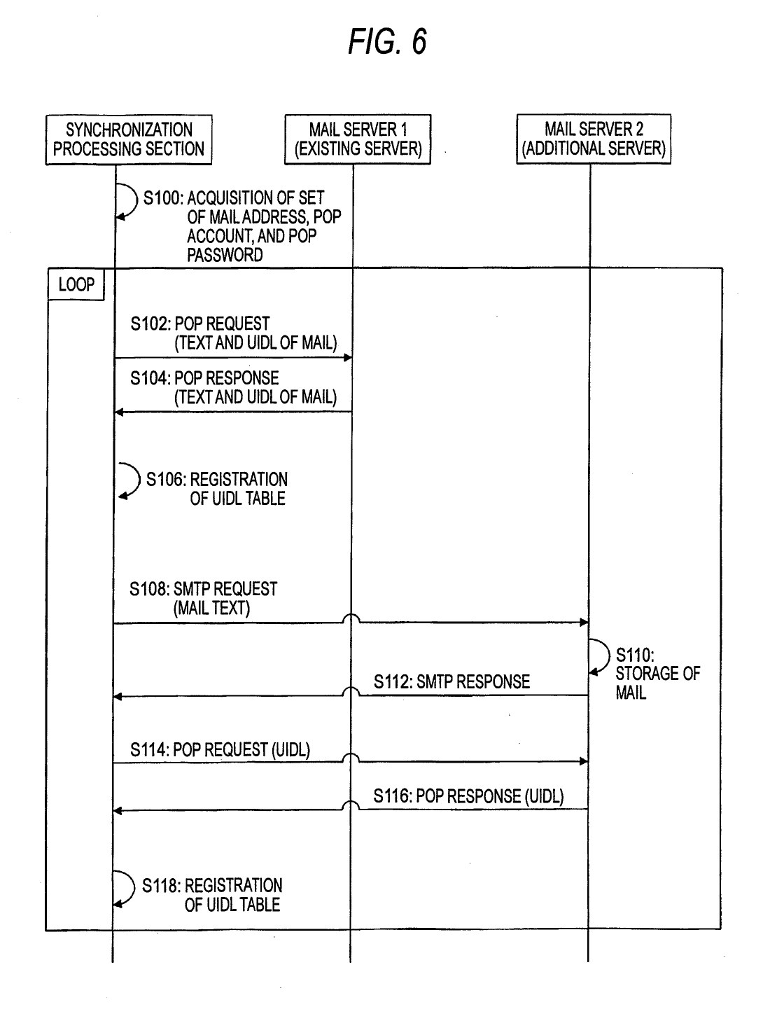

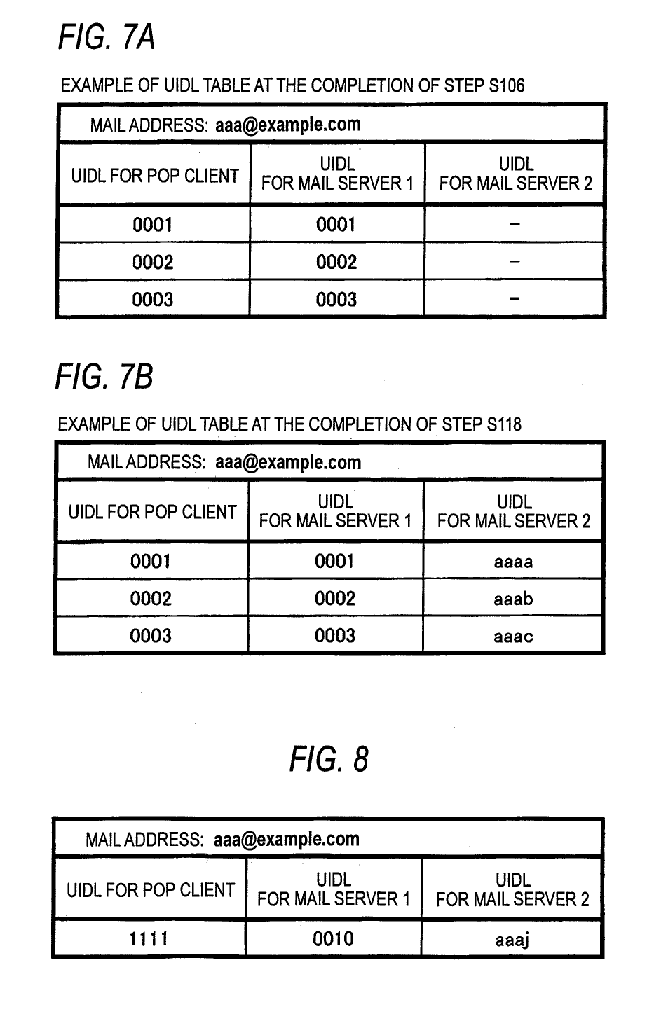

Referring to FIGS. 6 and 7, an example of the operation of a system when adding a mail server to the system will be described. Here, the case of multiplexing one mail server which is already operating will be described as an example. In explanation of this example, the mail server in operation is called a mail server 1 and the new mail server added for multiplexing of the mail server 1 is called a mail server 2.

First, a mail account table with the same content as a mail account table in the mail DB 100 of the mail server 10 in operation is stored in the mail DB 100 of the added mail server 2 and the storage section 200 of the electronic mail proxy device 20 by instruction of a system manager or the like. Then, an operation based on the sequence illustrated in FIG. 6 is started, and an electronic mail stored in the mail DB 100 of the mail server 1 is synchronized with the mail DB 100 of the mail server 2 and a UIDL table is created in the electronic mail proxy device 20 and stored in the storage section 200.

If the sequence in FIG. 6 is started, the synchronization processing section 220 of the electronic mail proxy device 20 acquires a set of mail address, POP account, and POP password from the mail account table of the storage section 200 (step S100). Then, processing in steps S102 to S118 is repeated for every set (mail address, POP account, and POP password) acquired in step S100.

The synchronization processing section 220 requests return of the text and UIDL of an electronic mail addressed to a current mail address to be processed by sending a POP request to the mail server 1 using the current POP account and POP password to be processed (step S102). For example, when the mail address “aaa@example.com” of the mail account table shown in the example of FIG. 3 is an object to be processed, the synchronization processing section 220 sends a POP request using corresponding POP account “aaa” and POP password “password_of_aaa” in order to request return of the text and UIDL of each electronic mail item which is stored in the mail DB 100 of the mail server 1 as electronic mail addressed to the mail address “aaa@example.com”.

In response to the POP request in step S102, the POP processing section 104 of the mail server 1 returns a POP response including the text and UIDL of the electronic mail addressed to the mail address to be processed (step S104).

After receiving the POP response, the UIDL table managing section 224 registers each UIDL included in the POP response in a UIDL table (step S106). In step S106, the UIDL table managing section 224 newly creates a UIDL table of the current mail address to be processed and sets the value of the UIDL received in step S104 in the item of the UIDL for the mail server 1 of the UIDL table, for example. In addition, as a UIDL for a POP client corresponding to the set UIDL for each mail server 1, the UIDL table managing section 224 sets the same value as the UIDL for the mail server 1. This is to maintain the matching between a UIDL, which is stored in the client terminal 30 that already acquired a UIDL from the mail server 1, and a UIDL for a POP client, which is notified from the electronic mail proxy device 20 to the client terminal 30 after the end of the sequence shown in the example of FIG. 6.

FIG. 7A shows an example of the content of a UIDL table when step S106 has been completed. FIG. 7A shows an example when three electronic mail items addressed to the mail address “aaa@example.com” to be processed are stored in the mail DB 100 of the mail server 1 and the synchronization processing section 220 acquires UIDLs “0001”, “0002”, and “0003” of the electronic mail items in step S104. At this point in time, the value of the item of the UIDL for the mail server 2 of the UIDL table is “Null (−)”.

Referring back to FIG. 6, the mail server synchronization section 222 of the synchronization processing section 220 sends an SMTP request including the text of each electronic mail item, which was acquired in step S104, to the new mail server 2 added (step S108). In this case, the mail address to be processed is set as the destination address of each electronic mail item. For example, the corresponding mail address is set as the destination address of each electronic mail item by designating a current mail address to be processed using a command “RCPT TO” which designates a recipient (destination) of an electronic mail to be transmitted by the SMTP.

In the mail server 2 which received the SMTP request in step S108, the SMTP processing section 102 stores each electronic mail item of an object, to which the SMTP request is to be transmitted, in the mail DB 100 as an electronic mail addressed to the mail address because the destination address of each electronic mail item to be transmitted is a mail address to be managed (that is, the destination address of each electronic mail item to be transmitted is registered in the mail account table) (step S110). Then, the SMTP processing section 102 of the mail server 2 returns an SMTP response indicating that the processing according to the SMTP request has been completed (step S112).

The UIDL table managing section 224 of the synchronization processing section 220 which has received the SMTP response in step S112 requests return of a UIDL of each electronic mail item addressed to the current mail address to be processed by sending a POP request to the mail server 2 (step S114).

In response to the POP request in step S114, the POP processing section 104 of the mail server 2 returns a POP response including a UIDL of each electronic mail item addressed to the mail address related to the POP request (step S116). The UIDL included in the POP response is a UIDL that the POP processing section 104 of the mail server 2 gives to each electronic mail item stored in the mail DB 100 of the mail server 2 in step S110.

The UIDL table managing section 224 of the synchronization processing section 220 which received the POP response in step S116 registers the UIDL included in the POP response in the UIDL table (step S118). In step S118, the UIDL table managing section 224 sets the value of the UIDL acquired from the mail server 2 in the item of a UIDL for the mail server 2, in the UIDL table (refer to FIG. 7A) in which a UIDL for a POP client and a UIDL for the mail server 1 were registered in step S106. Regarding to which UIDL for the mail server 1 which of the UIDLs acquired from the mail server 2 is to be matched, it is preferable to specify this, for example, by sending a further POP request to the mail server 2 to acquire the text of an electronic mail of each UIDL and comparing it with the text of each electronic mail item acquired from the mail server 1 in step S104. In other words, it is preferable that UIDLs of electronic mail items with the text of the same content, among electronic mail items acquired from the mail server 1 and the mail server 2, are matched to each other. Instead of comparing the text of electronic mail items, it is also possible to acquire the data size of each electronic mail item from the mail server 1 and the mail server 2 using the command “LIST” of POP, which requests the data size of each electronic mail item, and to match UIDLs of electronic mail items with the same size. Alternatively, it is also possible to acquire the header information (including a sender, a recipient, transmission date and time, and the like) of each electronic mail item from the mail server 1 and the mail server 2 by POP request and to match UIDLs of electronic mail items, whose header information acquired is the same. Also in all of the above examples, UIDLs, which are stored in the mail DBs 100 of the mail server 1 and the mail server 2 and which are given to the same electronic mail by the mail server 1 and the mail server 2, are matched to each other and registered in a UIDL table.

FIG. 7B shows an example of the data content of a UIDL table when step S118 has been completed. FIG. 7B shows an example where the value of a UIDL for the mail server 2 is registered in the UIDL table shown in the example of FIG. 7A when step S106 has been completed. Referring to a line including a UIDL “0001” for the mail server 1 in the table shown in FIG. 7B, it may be seen that a UIDL “aaaa” for the mail server 2 is given to an electronic mail corresponding to the line in the mail server 2.

By performing the procedure of steps S102 to S118 described above for every mail address acquired in step S100, electronic mail items stored for every mail address managed in the mail DB 100 of the mail server 1 are similarly stored in the mail DB 100 of the mail server 2. In addition, a UIDL table of each mail address is created in the electronic mail proxy device 20 and stored in the storage section 200.

Also in the case of building a system including three or more mail servers 10 by adding a new mail server after the sequence in the example of FIG. 6 ends, a UIDL table is updated by performing synchronization between the mail server 10 in operation and the new mail server 10 basically using the same procedure as in the example of FIG. 6. In this case, it is preferable to set one of the plurality of mail servers 10 in operation to the mail server 1 in the example of FIG. 6 and set the newly added mail server to the mail server 2. In addition, in the processing of registering a UIDL acquired from the mail server 1 in a UIDL table (step S106), registration of a UIDL for the server 1 which was already registered in the UIDL table is omitted.

In the sequence in the example of FIG. 6, it is not necessary to change software or a file system of the mail server 10 in operation in connection with adding the new mail server 10 to the system. In addition, even if software or file systems of the mail server 10 in operation and the added mail server 10 are different, there is no problem in execution of the sequence in the example of FIG. 6 as long as mail account tables with the same content are set for both the mail servers.

[POP Access (Reception of an Electronic Mail)]

Referring to FIGS. 8 to 11, an example of the operation of a system when the client terminal 30 receives an electronic mail by POP access will be described. Here, as a specific example for explanation, it is assumed that a system includes two mail servers 10 (mail server 1 and mail server 2) and a UIDL table of a mail address “aaa@sampIe.com” to be processed has the content shown in FIG. 8.

Referring to FIG. 8, one electronic mail item is stored in the mail DB 100 of each of the mail servers 1 and 2 as electronic mail addressed to the mail address “aaa@sampIe.com”, and the mail server 1 gives a UIDL “0010” to the electronic mail and the mail server 2 gives a UIDL “aaaj” to the electronic mail. In addition, a UIDL for a POP client which is given to the electronic mail by the electronic mail proxy device 20 is “1111”.

When a client terminal receives an electronic mail from a mail server, the electronic mail received by the client terminal may be left in the mail server or the received electronic mail may be deleted from the mail server. Whether to leave a received electronic mail on a mail server is set by a user of each mail address, for example. Hereinbelow, an example of the operation of a system when receiving an electronic mail will be described in a case where a received electronic mail is set to be left in a mail server and a case where a received electronic mail is set not to be left in a mail server.

(1) When a Received Electronic Mail is Set to be Left on a Mail Server

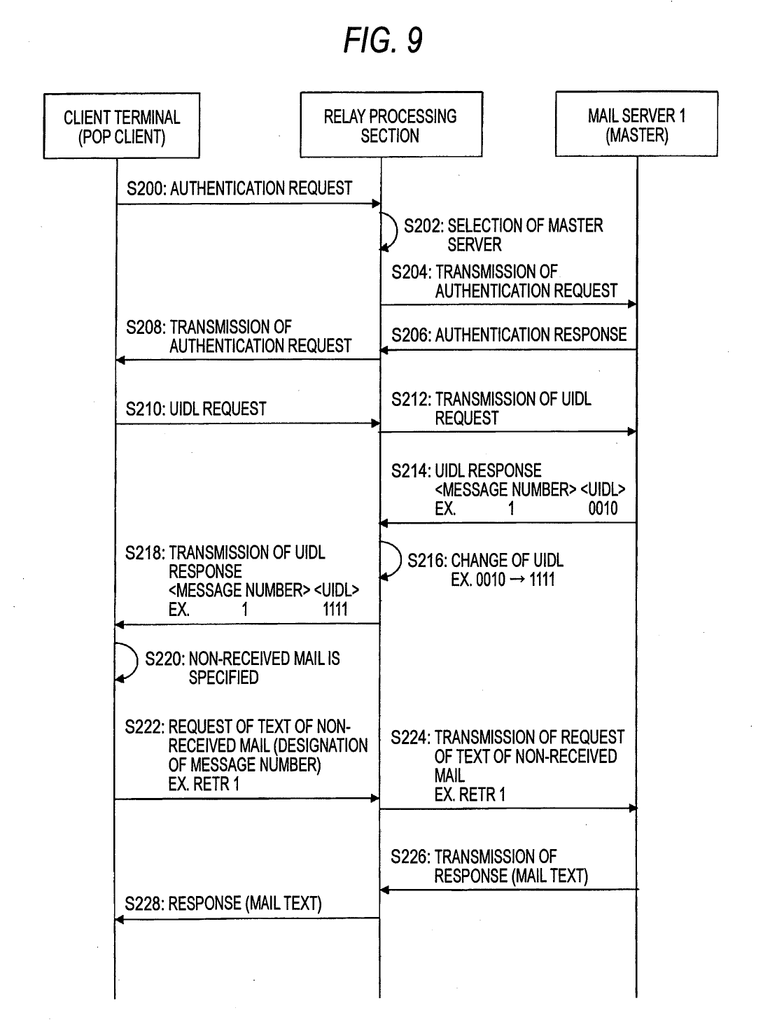

FIG. 9 is a sequence diagram showing an example of the operation of a system when a received electronic mail is set to be left on a mail server. In the sequence shown in the example of FIG. 9, all requests from the client terminal 30 are POP requests.

First, the client terminal 30 sends an authentication request to the mail server 10 (step S200). A POP account and a POP password of a user of the client terminal 30 are included in the authentication request. This authentication request is received by the electronic mail proxy device 20.

The relay processing section 210 of the electronic mail proxy device 20 which has received the authentication request in step S200 selects one master server from the plurality of (two in this example) mail servers 10 (step S202). For example, it is preferable to select one of the plurality of mail servers 10 as a master server by round-robin scheduling. Alternatively, it is possible to set priorities in advance for the plurality of mail servers 10, check the operations sequentially from the mail server 10 with a high priority, and select as a master server one with the highest priority among the mail servers 10 which are normally operating, for example. In this example, it is assumed that the mail server 1 is selected as a master server.

The data relay section 212 of the relay processing section 210 transmits the authentication request from the client terminal 30 as it is to the mail server 1 which is a master server selected in step S202 (step S204).

The POP processing section 104 of the mail server 1 which has received the authentication request in step S204 performs user authentication by comparing a set of POP account and POP password, which are registered in the mail account table of the mail DB 100 of the mail server 1, with a set of POP account and POP password, which are included in the authentication request transmitted in step S204, and sends a response regarding whether the authentication has succeeded or failed (step S206). This response is received by the electronic mail proxy device 20 and then transmitted to the client terminal 30 by the data relay section 212 (step S208).

Now, an example of the sequence when the authentication response (steps S206 and S208) indicates a success of authentication will be described. When the authentication has failed in the POP processing section 104 of the mail server 1, the sequence shown in the example of FIG. 9 ends without performing processing described below.

The client terminal 30 which has received the authentication response from the mail server 1 sends a UIDL request (step S210). In this example, in step S210, the client terminal 30 requests UIDLs of all electronic mail items, which are stored in the mail DB 100 of the mail server 1, as electronic mail items addressed to the mail address (mail address to be processed) of the user authenticated in steps S200 to S208.

The UIDL request in step S210 is received by the electronic mail proxy device 20 and then transmitted to the mail server 1 by the data relay section 212 (step S212).

The POP processing section 104 of the mail server 1 which has received the UIDL request returns a response including a UIDL of the electronic mail addressed to the mail address to be processed which is stored in the mail DB 100 (step S214). This response includes a set of message number and UIDL of each electronic mail item. The message number is a number which is given by the POP processing section 104 for identification of an electronic mail in communication according to the POP. This message number is a different number from a UIDL. The POP includes a command with a format of designating an electronic mail to be processed using a message number. Accordingly, when returning a response including the information (for example, a UIDL or the text) regarding each electronic mail item, the POP processing section 104 includes a set of message number of each electronic mail item and the information regarding the electronic mail in the response. In this example, in step S214, the POP processing section 104 returns a response, which includes a set of message number “1” and UIDL “0010” (refer to FIG. 8), for one electronic mail item addressed to the mail address “aaa@example.com” to be processed which is stored in the mail DB 100 of the mail server 1.

The response in step S214 is received by the electronic mail proxy device 20. Since the received response includes a UIDL which is given to the electronic mail by the mail server 1, the UIDL change section 214 of the relay processing section 210 changes the UIDL in the response to a UIDL for a POP client referring to the UIDL table (step S216). In this example, the UIDL change section 214 replaces the UIDL “0010” in the response with a UIDL “1111” for a POP client which is matched to the UIDL “0010” for the mail server 1 in the UIDL table shown in FIG. 8.

After step S216, the data relay section 212 transmits a response after UIDL change to the client terminal 30 (step S218). In this example, the response transmitted to the client terminal 30 includes a set of message number “1” in the response returned from the mail server 1 and the UIDL “1111” after the change in step S216.

Using the UIDL received in step S218, the client terminal 30 specifies an electronic mail which has not been received yet (step S220). The client terminal 30 saves the UIDL, which has been received by the sequence until step S218 according to the UIDL request, in its own storage device. In this case, a non-received electronic mail is specified by checking whether or not a UIDL which is not stored in the storage device is present in the UIDLs received in step S218. That is, when a UIDL which is not stored in the storage device is received in step S218, an electronic mail of the UIDL is specified as a non-received electronic mail. In this example, the UIDL “1111” that the client terminal 30 receives in step S218 is assumed to be a UIDL of a non-received electronic mail.

If a non-received electronic mail is specified, the client terminal 30 requests the text of the specified electronic mail (step S222). As a command of POP for this request, for example, “RETR<message number>” may be used. The “RETR” command is a command which requests return of a whole electronic mail of the designated message number. In step S222, the client terminal 30 creates a “RETR” command which designates a message number (“1” in this example) corresponding to the UIDL of the non-received electronic mail specified in step S220 and transmits it to the mail server 1.

The request in step S222 is received by the electronic mail proxy device 20 and then transmitted to the mail server 1 by the data relay section 212 (step S224).

The POP processing section 104 of the mail server 1 returns a response, which includes the text of the electronic mail of the designated message number, in response to the request transmitted in step S224 (step S226). In this example, a response including the whole electronic mail (that is, an electronic mail of the UIDL “0010” for the mail server 1) of the message number is returned in response to the “RETR” command which designates the message number “1”.

The data relay section 212 of the electronic mail proxy device 20 receives the response in step S226 and transmits it to the client terminal 30 (step S228).

According to the sequence shown in the example of FIG. 9, the client terminal 30 receives a non-received electronic mail among electronic mail items addressed to the mail address to be processed which are stored in the mail DB 100 of the mail server 1.

In the sequence shown in the example of FIG. 9, the mail server 1 simply transmits a UIDL and the text of an electronic mail in the mail DB 100 to the client terminal 30 and does not change the data content of the mail DB 100. For this reason, it is not necessary to perform synchronization with the mail server 1 for the mail DB 100 of another mail server 2 in the system. Therefore, processing of the synchronization processing section 220 of the electronic mail proxy device 20 is not performed.

(2) When Electronic Mail Received is Set not to be Left on a Mail Server

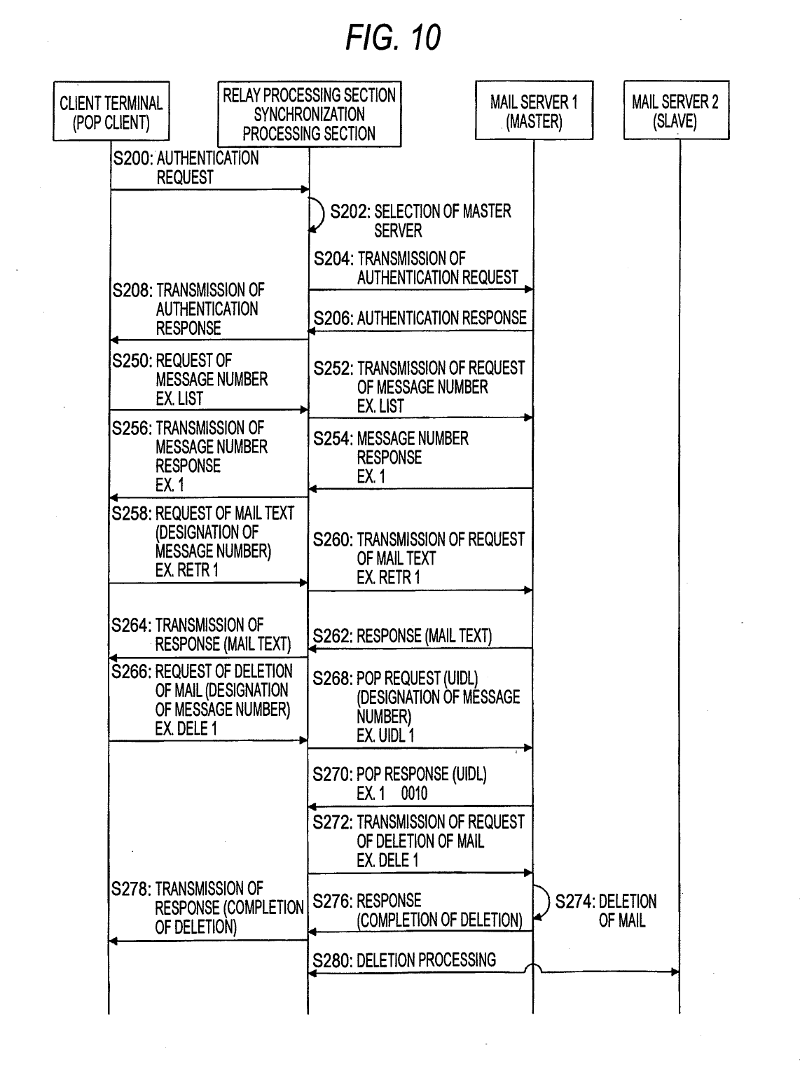

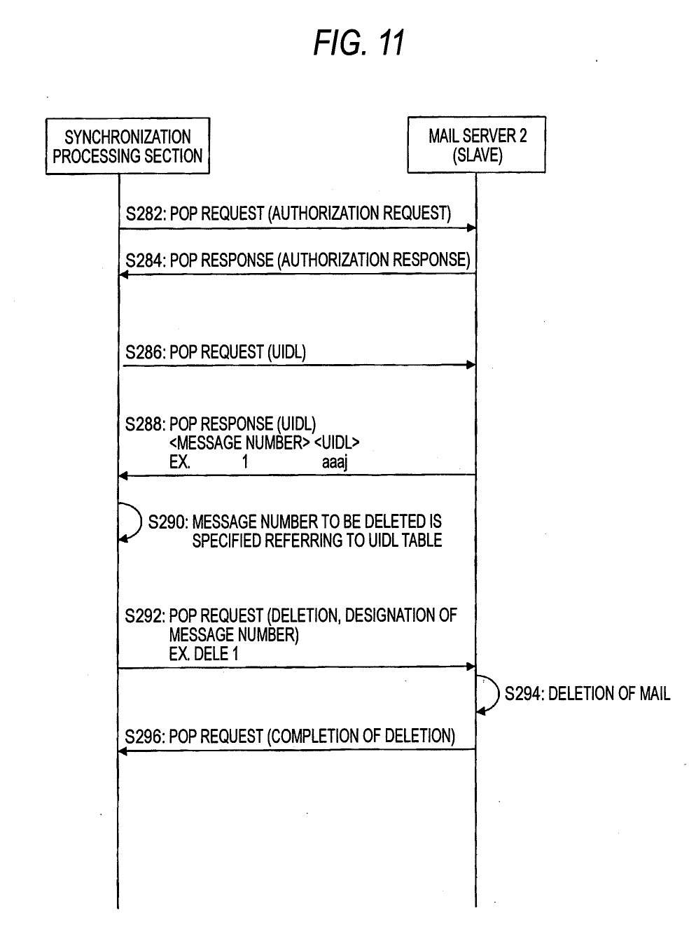

Next, an example of the operation of a system when a received electronic mail is set not to be left in the mail server 10 will be described with reference to FIGS. 10 and 11.

First, FIG. 10 is referred to. Here, an explanation regarding authenticating processing (steps S200 to S208) according to the POP will be omitted because it is the same as that in steps S200 to S208 shown in FIG. 9.

If authentication of the POP is completed, the client terminal 30 requests a message number of an electronic mail addressed to a mail address to be processed (step S250). In this example, the client terminal 30 requests message numbers of all electronic mail items stored in the mail DB 100 of the mail server 1 as electronic mail addressed to a mail address to be processed. For example, it is preferable that the request in step S250 is performed using the “LIST” command of the POP. The “LIST” command is a command which requests a response including a message number of each electronic mail item and the data size of the electronic mail.

The message number request in step S250 is received by the electronic mail proxy device 20 and then transmitted to the mail server 1, which is a master server, by the data relay section 212 of the relay processing section 210 (step S252).

The POP processing section 104 of the mail server 1 to which the request of message number has been transmitted from the electronic mail proxy device 20 returns a message number of each electronic mail item addressed to the mail address to be processed which is stored in the mail DB 100 (step S254). In this example, as shown in FIG. 8, one electronic mail item (UIDL is “0010”) addressed to the mail address “aaa@example.com” to be processed is stored in the mail DB 100. Accordingly, a response including the message number “1” given by the mail server 1 for the one electronic mail item is returned.

The response in step S254 is transmitted to the client terminal 30 by the data relay section 212 of the relay processing section 210 provided in the electronic mail proxy device 20 (step S256).

The client terminal 30 requests the text of the electronic mail of the message number received in step S256 (step S258). In step S258, the client terminal 30 requests the text of electronic mail for all message numbers returned from the mail server 1. This is because a received electronic mail is set not to be left on a mail server in this example and therefore, it may be regarded that all electronic mail items stored in the mail DB 100 of the mail server 1 have not yet been received. In addition, in this example where the client terminal 30 receives a response including the message number “1”, the request in step S258 is performed by designating the message number “1” using the above-described “RETR” command.

The request in step S258 is transmitted to the mail server 1 by the data relay section 212 of the relay processing section 210 provided in the electronic mail proxy device 20 (step S260).

The POP processing section 104 of the mail server 1 returns a response including the text of electronic mail of the message number designated in the transmitted request (step S262), and the data relay section 212 of the relay processing section 210 transmits the response to the client terminal 30 (step S264).

If the text of the electronic mail is received in step S264, the client terminal 30 requests deletion of the electronic mail from the mail server 1 (step S266). This request is preferably performed using a “DELE” command of the POP. The “DELE” command is a command of the POP which designates a message number and requests deletion of electronic mail of the message number from a mail server. In this example, the client terminal 30 sends the request in step S266 using the “DELE” command which designates the message number “1”.

In the electronic mail proxy device 20 which has received the deletion request in step S266, the relay processing section 210 notifies the synchronization processing section 220 that the data content of the mail DB 100 has been changed by deleting electronic mail from the mail DB 100 of the mail server in response to the deletion request. The UIDL table managing section 224 of the synchronization processing section 220 which has received the notification sends a POP request to the mail server 1 in order to request a UIDL of electronic mail deletion of which has been requested by the client terminal 30 (step S268). In this example, the UIDL table managing section 224 requests a UIDL of electronic mail of the message number “1” designated by the “DELE” command from the client terminal 30.

In response to the request of a UIDL in step S268, the POP processing section 104 of the mail server 1 returns a response including the UIDL of the electronic mail of the message number designated by the request (step S270). In this example, in the mail server 1, the UIDL “0010” is given to the electronic mail of the message number “1” (refer to FIG. 8). Accordingly, this UIDL “0010” is a response in step S270.

The UIDL of electronic mail to be deleted in the mail server 1, which has been acquired by the synchronization processing section 220 in steps S268 and S270, is used in processing of deleting the electronic mail from the mail DB 100 of the mail server 2. This deletion processing will be described later with reference to FIG. 11.

If the synchronization processing section 220 of the electronic mail proxy device 20 acquires the UIDL of the electronic mail to be deleted from the mail server 1, the data relay section 212 of the relay processing section 210 transmits to the mail server 1 the deletion request received from the client terminal 30 in step S266 (step S272). The POP processing section 104 of the mail server 1 which has received the deletion request deletes the electronic mail of the message number designated by the deletion request from the mail DB 100 (step S274). In this example, electronic mail of the UIDL “0010” (refer to FIG. 8) is deleted. If the deletion is completed, the POP processing section 104 sends a response for notifying that the deletion has been completed (step S276). This response is transmitted to the client terminal 30 by the data relay section 212 of the electronic mail proxy device 20 (step S278).

As described above, the client terminal 30 receives electronic mail, which is addressed to a mail address to be processed, from the mail server 10 according to the sequence until step S278 in FIG. 10. In relation to the reception of electronic mail, the processing of the client terminal 30 is completed until step S278.

After step S278, the electronic mail proxy device 20 performs processing of synchronizing the data content of the mail DB 100 of each of other mail servers (slave servers) of the master server with the data content of the mail DB 100 of the master server. In this example, the synchronization processing section 220 of the electronic mail proxy device 20 performs processing for deleting electronic mail deleted from the mail server 1, which is a master server, from the mail DB 100 of the mail server 2 which is a slave server (step S280).

FIG. 11 is a sequence diagram showing an example of a detailed procedure for the deletion processing in step S280 of FIG. 10.

Referring to FIG. 11, first, the mail server synchronization section 222 of the synchronization processing section 220 sends an authentication request according to the POP to the mail server 2 using a POP account and a POP password corresponding to the mail address to be processed in the sequence shown in FIG. 10 (step S282).

The POP processing section 104 of the mail server 2 performs authentication in response to the authentication request in step S282, and returns a response including the success or failure (step S284). Here, it is assumed that the authentication has succeeded.

If the response indicating the success of authentication is received in step S284, the UIDL table managing section 224 of the synchronization processing section 220 requests a UIDL of each electronic mail item, which is addressed to the mail address (that is, a mail address to be processed in the sequence shown in FIG. 10) of the authenticated user, to the mail server 2 according to the POP (step S286).

In response to the request in step S286, the POP processing section 104 of the mail server 2 returns a response including a UIDL of each electronic mail item addressed to the mail address to be processed which is stored in the mail DB 100 of the mail server 2 (step S288). In this example where one electronic mail item addressed to the mail address “aaa@sampIe.com” to be processed is stored in the mail DB 100, the POP processing section 104 of the mail server 2 returns a response including a set of message number “1” and UIDL “aaaj” (refer to FIG. 8) applied to this electronic mail.

If the response in step S288 is received, the synchronization processing section 220 specifies a message number of the electronic mail to be deleted referring to the UIDL table in the storage section 200 (step S290). In step S290, for example, a UIDL for the mail server 2 matched to a UIDL of electronic mail to be deleted, which has been received from the mail server 1 in step S270 of FIG. 10, among UIDLs received from the mail server 2 in step S288 is specified from the UIDL table. The UIDL for the mail server 2 specified in this way is a UIDL that the mail server 2 gives to the electronic mail to be deleted. Then, in the response received in step S288, a message number matched to the UIDL for the mail server 2 specified as described above is specified. Referring to the example of the UIDL table shown in FIG. 8, the UIDL “aaaj” included in the response from the mail server 2 in step S288 is matched to the UIDL “0010” of the electronic mail to be deleted in the mail server 1 which was acquired in step S270 of FIG. 10. Accordingly, the synchronization processing section 220 specifies the electronic mail of the UIDL “aaaj” for the mail server 2 as an object to be deleted. In addition, since the message number “1” is matched to the UIDL “aaaj” in the response from the mail server 2 in step S288 like the example described above, “1” is specified as a message number of the electronic mail to be deleted.

The mail server synchronization section 222 of the synchronization processing section 220 designates the message number to be deleted, which has been specified in step S290, and sends a POP request to the mail server 2 in order to request deletion of the electronic mail (step S292). For example, the deletion request which designates the message number “1” in the above-described “DELE” command is sent.

In response to the deletion request in step S292, the POP processing section 104 of the mail server 2 deletes the electronic mail of the designated message number from the mail DB 100 (step S294). If the deletion is completed, the POP processing section 104 of the mail server 2 returns a response, which indicates that the deletion has been completed, to the synchronization processing section 220 (step S296).

As described above, since the electronic mail deleted from the mail server 1 which is a master server is also deleted from the mail server 2 which is a slave server according to the sequence described with reference to FIG. 11, the data content of the mail DB 100 of the two mail servers 1 and 2 is synchronized with each other.

In the above, the case where a system includes only two mail servers 10 has been described as an example. Also in the case where a system includes three or more mail servers 10, the sequence in the example shown in FIGS. 9 to 11 may be executed. In the case where a system includes three or more mail servers 10, the sequence in the example shown in FIG. 11 is executed for each of the other two or more mail servers 10 of a master server after the sequence in the example shown in FIG. 10.

[SMTP Access (Transmission of Electronic Mail)]

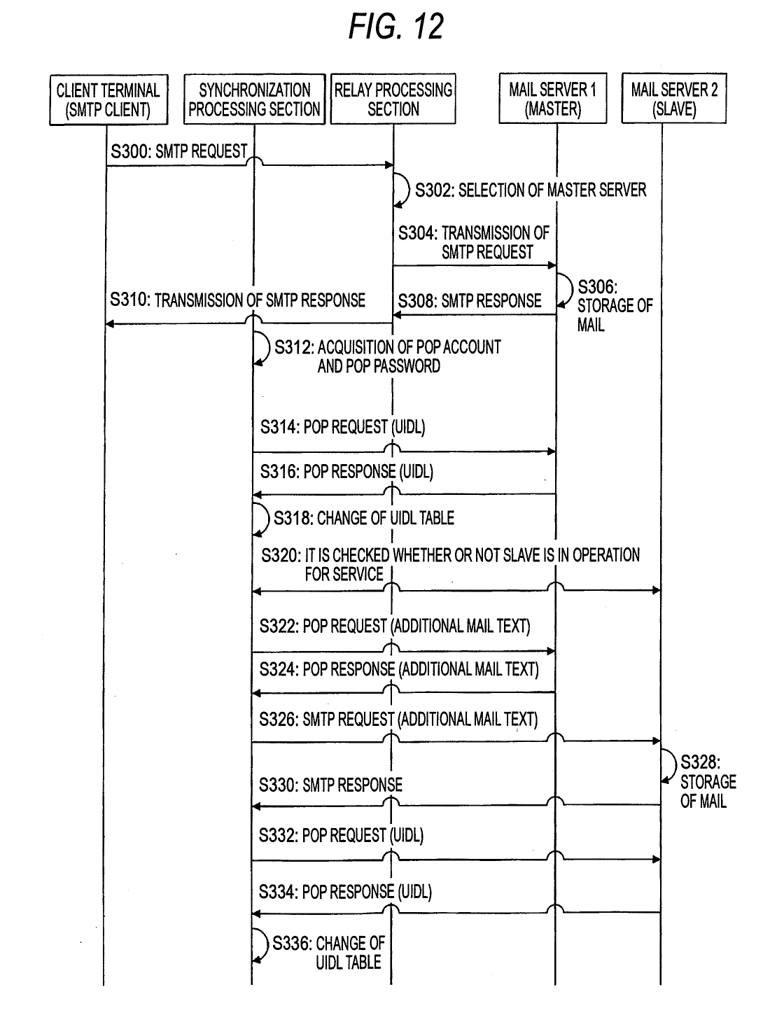

Referring to FIG. 12, an example of the operation of a system when electronic mail is transmitted by SMTP access will be described. In the following explanation, it is assumed that a system includes two mail servers 10-1 and 10-2. Moreover, an example of the case where the client terminal 30 sends an SMTP request to transmit electronic mail to a mail address managed by the mail servers 10-1 and 10-2 will be described below.

Referring to FIG. 12, the client terminal 30 sends an SMTP request including electronic mail to be transmitted to the mail server 10 (step S300). The sender of the electronic mail is set as a mail address of the user of the client terminal 30 that sent the request, and the destination address (recipient) is set as a mail address specified by the user. In this example, the destination address is assumed to be a mail address “aaa@example.com” managed by the mail server 10.

If the electronic mail proxy device 20 receives the SMTP request in step S300, the relay processing section 210 selects one master server from the plurality of mail servers 10 (step S302). A method of selecting the master server may be the same as the method described regarding step S202 in FIG. 10 in the example of the case of the POP access. In this example, it is assumed that the mail server 1 is selected as a master server.

The data relay section 212 of the relay processing section 210 transmits an SMTP request in step S300 to the mail server 1 which is a master server selected in step S302 (step S304).

The SMTP processing section 102 of the mail server 1 which has received this SMTP request checks the destination address of electronic mail to be transmitted which is related to the SMTP request. In this example, since the destination address is a mail address managed by the mail server 1 (mail address registered in the mail account table of the mail DB 100), the SMTP processing section 102 stores the electronic mail to be transmitted in the mail DB 100 as an electronic mail addressed to the mail address of the destination address (step S306). In addition, when the destination address of the electronic mail to be transmitted related to the SMTP request received in step S304 is not a mail address which is managed, the SMTP processing section 102 transmits the electronic mail, which is to be transmitted, to the other domain mail server 50 corresponding to the domain name of the destination address. In this case, the electronic mail to be transmitted is not stored in the mail DB 100. In addition, if the storage of electronic mail into the mail DB 100 is not performed, processing from step S312, which will be described later, is not performed either.

After step S306, the SMTP processing section 102 returns a response indicating that the processing according to the SMTP request has been completed (step S308), and this response is transmitted to the client terminal 30 by the data relay section 212 of the relay processing section 210 of the electronic mail proxy device 20 (step S310).

Processing with which the client terminal 30 is concerned in transmission of electronic mail ends in step S310. If the electronic mail to be transmitted is newly stored in the mail DB 100 of the mail server 1 by the SMTP request transmitted to the mail server 1, the data content of the mail DB 100 is changed. Accordingly, the relay processing section 210 of the electronic mail proxy device 20 notifies the synchronization processing section 220 that the data content of the mail DB 100 has been changed. The synchronization processing section 220 which has received this notification performs processing of synchronizing the data content of the mail DB 100 of the slave server with the data content of the mail DB 100 of the master server. In this example, the synchronization processing section 220 also stores the electronic mail, which has been newly stored in the mail DB 100 of the mail server 1, in the mail DB 100 of the other mail server 2 (slave server) by processing from step S312.

In step S312, the synchronization processing section 220 acquires a POP account and a POP password, which correspond to the destination address of the electronic mail to be transmitted related to the SMTP request, from the mail account table stored in the storage section 200. In this example where the destination address of the electronic mail to be transmitted is “aaa@example.com”, a POP account “aaa” and a POP password “password_of_aaa” corresponding to the mail address are acquired by referring to the mail account table shown in the example of FIG. 3.

Using the POP account and the POP password acquired in step S312, the UIDL table managing section 224 of the synchronization processing section 220 performs POP access to the mail server 1, which is a master server, for authentication (not shown in FIG. 12). Then, the UIDL table managing section 224 requests a UIDL of the electronic mail, which is addressed to the mail address of the authenticated user, to the mail server 1 (step S314). The mail address of the authenticated user is the destination address “aaa@example.com” of the electronic mail to be transmitted related to the SMTP request. Accordingly, in step S314, a UIDL of electronic mail stored in the mail DB 100 of the mail server 1 as electronic mail addressed to the destination address according to the SMTP request is requested.

In response to the UIDL request in step S314, the POP processing section 104 of the mail server 1 returns a response including a UIDL of electronic mail in the mail DB 100 which is stored as the electronic mail addressed to the mail address that has been requested (step S316). This response includes not only a UIDL of electronic mail, which is stored in the mail DB 100 by this execution of step S306 but also a UIDL of electronic mail, which is stored in the mail DB 100 in the sequence of the example of FIG. 12 executed previously. Referring to FIG. 5 as a specific example, the content (UIDLs “1001” and “1002” for the mail server 1) of lines L1 and L2 is already registered in a UIDL table and a UIDL of electronic mail newly registered in the mail DB 100 of the mail server 1 in step S306 is “1003”. In the specific example, the UIDL response in step S316 includes the UIDLs “1001”, “1002”, and “1003”. In addition, the UIDL response in step S316 includes a set of message number and UIDL as described above with reference to FIG. 9 and the like. In the specific example described above, it is a UIDL response including three sets (1, 1001), (2, 1002), and (3, 1003) of (message number and UIDL), for example.

In the electronic mail proxy device 20 which has received the response in step S316, the UIDL table managing section 224 updates the UIDL table in the storage section 200 using the UIDL included in the response (step S318). For example, the UIDL table managing section 224 compares the UIDL for the mail server 1 registered in the UIDL table with the UIDL included in the response in step S316 and specifies a UIDL, which is not registered in the UIDL table, among the UIDLs included in the response. In the specific example above referring to FIG. 5, the registered UIDLs “1001” and “1002” for the mail server 1 of the lines L1 and L2 are compared with the UIDLs “1001”, “1002”, and “1003” included in the UIDL response, and “1003” is specified as an unregistered UIDL. Then, an information record corresponding to the electronic mail of the specified UIDL is added to the UIDL table, and the value of the specified UIDL is set in the item of the UIDL for the mail server 1 of the added information record. In addition, the value of the newly created UIDL for a POP client is set in the item of a UIDL for a POP client of the added line. In the specific example referring to FIG. 5, a line L3 is added to the UIDL table. As a result, a new UIDL “1003” for the mail server 1 and a new UIDL “kkkk” for a POP client corresponding thereto are set. At this point in time, the value of the item of the UIDL for the mail server 2 in the line L3 of FIG. 5 “Null”.

In addition, the UIDL for a POP client registered so as to be matched to the new UIDL for the mail server 1 in step S318 may be the same value as the value of the UIDL for the mail server 1 or may be a different value. In step S106 in the example (addition of a mail server) of the sequence shown in FIG. 6, a client terminal 30 which has acquired a UIDL from the mail server 1 may be present. Accordingly, it is necessary to set the UIDL acquired from the mail server 1 and the UIDL for a POP client to the same value. In this example, however, since the UIDL for the mail server 1 newly registered in the UIDL table is a UIDL of the electronic mail newly stored in the mail DB 100 of the mail server 1 in step S306, the client terminal 30 which has acquired the UIDL is not present at the point in time of step S318. Accordingly, in step S318, a UIDL for a POP client, which is a different value from the new UIDL for the mail server 1, may be registered in the UIDL table so as to be matched to the new UIDL for the mail server 1.

If the update of the UIDL table is completed, the mail server synchronization section 222 of the synchronization processing section 220 checks whether or not the mail server 2, which is a slave server, is in operation for service (step S320). If the mail server 2 is in operation, processing from step S322 is started. If the mail server 2 is not in operation, the start of processing from step S322 is delayed until the mail server 2 starts the operation of the service. When electronic mail stored in the mail DB 100 of the mail server 1 in step S306 is deleted from the mail DB 100 of the mail server 1 according to the sequence in the above example shown in FIG. 10 in the standby state, the processing from step S322 is not performed even if the mail server 2 starts the service operation.

In step S322, first, the mail server synchronization section 222 sends a POP request to the mail server 1 in order to request the text of the electronic mail newly stored in the mail DB 100 this time. For example, the mail server synchronization section 222 specifies a message number, which corresponds to the UIDL for the mail server 1 newly registered in the UIDL table in step S318, from the response in step S316, and requests the text of electronic mail of the specified message number. In the above specific example referring to FIG. 5, the message number corresponding to the UIDL “1003” for the mail server 1 newly registered is “3”. Accordingly, it is preferable to designate the specified message number “3” and send a request of the “RETR” command of the POP, for example.

In response to the request in step S322, the POP processing section 104 of the mail server 1 returns a response including the text of the designated electronic mail (step S324). Here, the text of the electronic mail stored in the mail DB 100 in step S306 is returned.

If the response in step S324 is received, the mail server synchronization section 222 of the synchronization processing section 220 sends an SMTP request to the mail server 2 with electronic mail including the text within the response in step S324 as an object to be transmitted (step S326). In this case, the mail server synchronization section 222 sets the destination address “aaa@example.com” of the electronic mail to be transmitted, which is related to the SMTP request in step S300, as the destination address of the electronic mail to be transmitted.

The SMTP processing section 102 of the mail server 2 which has received the request in step S326 stores the electronic mail to be transmitted in the mail DB 100 (step S328) and returns a response indicating that the processing according to the SMTP request has been completed (step S330). The processing in steps S328 and S330 may be the same as the processing in steps S306 and S308 performed by the mail server 1.

By the processing in steps S322 to S330, the electronic mail newly stored in the mail DB 100 of the mail server 1 is also stored in the mail DB 100 of the mail server 2.

After step S330, the UIDL table managing section 224 of the synchronization processing section 220 sends a POP request to the mail server 2 in order to request a UIDL of each electronic mail item addressed to the mail address to be processed (step S332).

In response to the request in step S332, a response including a UIDL is returned (step S334). In this response, the UIDL of the electronic mail newly stored in the mail DB 100 of the mail server 2 in step S328 is included. In the above specific example referring to FIG. 5, a UIDL response including UIDLs “aaax” and “aaay” (refer to UIDLs for the mail server 2 of the lines L1 and L2 in FIG. 5) of the electronic mails, which are stored in the mail DB 100 of the mail server 2, and a UIDL “aaaz” of the electronic mail newly stored is returned.

The UIDL table managing section 224 updates a UIDL table using the UIDLs included in the response in step S334 (step S336). It is preferable to perform the processing in step S336 according to the following procedure, for example. First, UIDLs for the mail server 2 registered in the UIDL table are compared with UIDLs included in the response in step S334, and a UIDL which is not registered in the UIDL table among the UIDLs included in the response is specified. In the specific example described above, “aaaz” is specified as an unregistered UIDL. In this specific example, there is only one unregistered UIDL. Accordingly, the UIDL table managing section 224 registers the unregistered UIDL “aaaz” in the UIDL table as a UIDL for the mail server 2 corresponding to the UIDL “1003” for the mail server 1 registered in step S318 (line L3 in FIG. 5). When there is plural of specified unregistered UIDLs, which UIDL of the unregistered UIDLs (for the mail server 2) corresponds to a UIDL for which mail server 1 is specified referring to the text, data size, or header information of each electronic mail item addressed to a mail address to be processed which is registered in each mail DB 100 of the mail server 1 and the mail server 2, for example, in the same manner as described in step S118 of FIG. 6. In addition, each unregistered UIDL for the mail server 2 is registered in the UIDL table so as to be matched to the corresponding UIDL for the mail server 1.

As described above, the electronic mail newly stored in the mail DB 100 of the mail server 1 which is a master server is also stored in the mail DB 100 of the mail server 2 which is a slave server by the processing in steps S312 to S336 of FIG. 12. In addition, when plural of slave servers is present, it is preferable to perform the processing in steps S320 to S336 for each slave server after step S318. Moreover, although the client terminal 30 sends an SMTP request for electronic mail transmission in the sequence shown in the example of FIG. 12, the other domain mail server 50 may send an SMTP request for the transmission of electronic mail addressed to a mail address managed by the mail server 10. Also in this case, the operations of the electronic mail proxy device 20 and the mail server 10 may be the same as those in the example shown in FIG. 12. In this case, in the example shown in FIG. 12, the other domain mail server 50 sends an SMTP request in step S300 and receives an SMTP response in step S310, instead of the client terminal 30.

According to the example of the exemplary embodiment described above, transmission and reception of electronic mail are realized by the same POP access and SMTP access as in the case where one mail server 10 communicates with the other party depending on the client terminal 30. In addition, even if different UIDLs are given to the same electronic mail in the plurality of mail servers 10, a UIDL notified to the client terminal 30 for a certain electronic mail is uniquely determined by using a UIDL table of the electronic mail proxy device 20.

[Modifications]

The exemplary embodiment of the invention is not limited to the example described above, and various kinds of modifications may also be made. For example, in the case of setting of deleting a received electronic mail from a mail server in the POP access, steps S268 and S270 in FIG. 10 may be omitted and synchronization between a master server and a slave server may be performed according to the following procedure after executing the deletion of electronic mail in the master server. First, a POP request is sent to a master server and each slave server to acquire a UIDL and the text of electronic mail addressed to a mail address to be processed from the master server and each slave server. Then, electronic mail with a UIDL and the text, which do not match the UIDL and the text acquired from the master server, is deleted from each slave server by the deletion request of the POP. As a result, the electronic mail deleted from the master server is also deleted from each slave server.

For example, in the case of the transmission of electronic mail by SMTP access, the electronic mail proxy device 20 may return an SMTP response after receiving an SMTP request from the client terminal 30 and then store electronic mail to be transmitted according to the SMTP request in each mail DB 100 of the plurality of mail servers 10, instead of the sequence shown in the example of FIG. 12. In this case, the electronic mail proxy device 20 stores a new electronic mail in each mail server 10 and updates a UIDL table by performing the processing in steps S326 to S336 in the example of FIG. 12 for each mail server 10, for example.

Moreover, in another modification, not only the mail server 10 but also the electronic mail proxy device 20 may be multiplexed. For example, the plurality of electronic mail proxy devices 20 is connected to the network 40-1 in the example of FIG. 1, and the contents of mail account tables and UIDL tables of the storage sections 200 of the plurality of electronic mail proxy devices 20 are synchronized with each other. The synchronization between the electronic mail proxy devices 20 is preferably performed by storing a copy of the content of the storage section 200 of a certain electronic mail proxy device 20 in the storage sections 200 of the other electronic mail proxy devices 20 through the network 40-1 or movable storage media, for example. When the plurality of electronic mail proxy devices 20 is used, for example, one of these is operated and the other electronic mail proxy devices 20 are in standby states. In addition, when a certain problem occurs in the electronic mail proxy device 20 in operation, one of the electronic mail proxy devices 20 in standby states is operated. The electronic mail proxy device 20 in a standby state may stand by (hot standby) in a state where it has started or may stand by in a state (warm standby) where it has not started.

In addition, although the exemplary embodiment and the modification described above are concerned with the transmission and reception of electronic mail, they are not limited to the electronic mail system and a server may be multiplexed in a system, in which a server manages the transmission and reception of data between client terminals, by the same configurations as in the exemplary embodiment and the modification described above. For example, a relay device which relays communication between a client and a server may hold an information table in which the identification information for each server, which is given to the same data in each of plural of servers, and the identification information for a client, which is notified to a client as identification information of the data, are matched with each other.

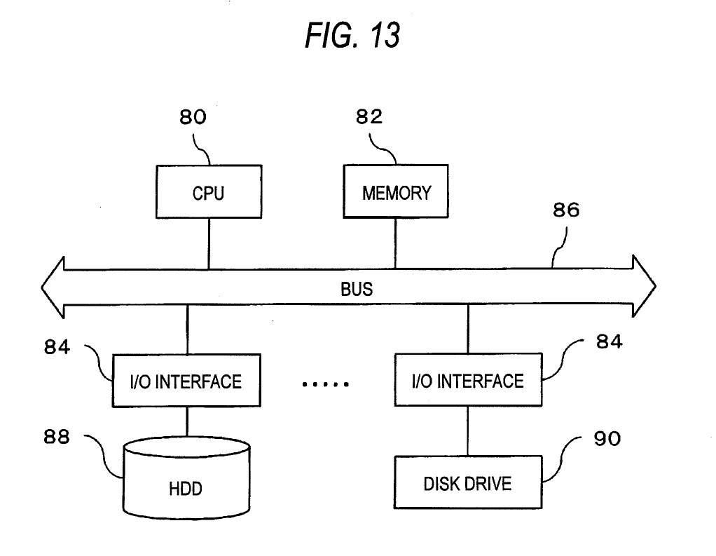

Typically, the electronic mail proxy device 20 described above is realized by causing a general-purpose computer to execute a computer readable medium in which a function or the processing content of each section of the electronic mail proxy device 20 is described. A computer includes, as hardware, a circuit configuration where a CPU (central processing unit) 80, a memory (primary storage) 82, various I/O (input/output) interfaces 84, and the like are connected to each other through a bus 86, for example, as shown in FIG. 13. In addition, a disk drive 90 for reading from portable nonvolatile recording media based on various specifications, such as an HDD (hard disk drive) 88, a CD, a DVD, and a flash memory, is connected to the bus 86 through the I/O interface 84, for example. Such a drive 88 or 90 functions as an external storage device for a memory. A computer readable medium in which the processing content in the exemplary embodiment is described is saved in a fixed storage device, such as the HDD 88, through a recording medium, such as a CD or a DVD, or through a network and is installed on a computer. The computer readable medium stored in the fixed storage device is loaded into the memory and executed by the CPU. As a result, the processing in the exemplary embodiment is realized. The same is true for the mail server 10 and the client terminal 30.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A data relay system comprising:
a plurality of server devices which manages data transmitted and received by a client device; and
a relay device which relays communication between the client device and each of the plurality of server devices,
wherein each of the plurality of server devices includes:
a data storage unit that stores data, which is addressed to a user of the client device, and identification information, which is given to the data by the server device, so as to match each other; and
a request processing unit that performs processing corresponding to a received request when a request for processing regarding the data stored in the data storage unit is received and transmitting a response including a result of the processing to a request source,
the relay device includes:
a synchronization unit that synchronizes the data in the data storage unit of each of the plurality of server devices by storing the data addressed to the user in the data storage unit of each of the plurality of server devices;
an identification information registration unit that acquires identification information, which is given by each server device for the data stored in the data storage unit of each server device by the synchronization unit, from each server device and registering identification information for a server, which is the acquired identification information, and identification information for a client, which is transmitted to the client device as identification information of the data, in an identification information storage unit so as to match each other; and
a relay processing unit that performs relay processing of receiving a request sent to the server devices by the client device and transmitting the request to one of the plurality of server devices and of receiving a response, which is transmitted in response to the request by the request processing unit of the server device that has received the request, and transmitting the response to the client device, and
when the response includes the identification information for a server, the relay processing unit replaces the identification information for a server included in the response with the identification information for a client, which is stored in the identification information storage unit so as to be matched to the identification information for a server, and then transmits the response to the client device.

2. The data relay system according to claim 1,
wherein when a storage request to store new data addressed to the user in the data storage unit is received, the request processing unit of each of the plurality of server devices stores the data, for which storage has been requested, in the data storage unit, gives new identification information to the data, and stores the given identification information and the data in the data storage unit so as to match each other,
the synchronization unit of the relay device transmits the storage request to each of the plurality of server devices when the relay processing unit receives the storage request from the client device, and
the identification information registration unit of the relay device acquires the identification information for a server, which is given by each of the plurality of server devices for the data requested for storage that has been transmitted by the synchronization unit, from each of the plurality of server devices, gives the identification information for a client to the data requested for storage, and registers the given identification information for a client and the identification information for each server acquired from each of the plurality of server devices in the identification information storage unit so as to match each other.

3. The data relay system according to claim 2,
wherein when a deletion request to delete the data stored in the data storage unit is received, the request processing unit of each of the plurality of server devices deletes the target data of the received deletion request from the data storage unit, and
when the relay processing unit transmits the deletion request to one of the plurality of server devices, the synchronization unit of the relay device acquires identification information for a server, which is given by the one server device for the data requested to be deleted, from the one server device and transmits a request for deletion of the data to each of the other server devices referring to the identification information for each server of the one server device corresponding to each of the other server devices which is stored in the identification information storage unit so as to be matched to the acquired identification information for a server.

4. The data relay system according to claim 2,
wherein when a new server device is made to operate in addition to the plurality of server devices in operation, the synchronization unit of the relay device acquires the data stored in the data storage unit and the identification information for a server, which is given to the data by the one server device, from one of the plurality of server devices in operation and transmits the storage request regarding the acquired data to the new server device, and the identification information registration unit of the relay device acquires the identification information for a server, which the new server device has given to the target data of the storage request transmitted from the synchronization unit to the new server device, from the new server device and registers the acquired identification information for a server in the identification information storage unit so as to be matched to the identification information for a server that the synchronization unit has acquired from one of the plurality of server devices in operation.

5. A relay device which relays communication between each of a plurality of server devices, which manages data transmitted and received by a client device, and the client device, comprising:
a synchronization unit that synchronizes data in a data storage unit of each of the plurality of server devices by storing the data addressed to a user in the data storage unit of each of the plurality of server devices;
an identification information registration unit that acquires identification information, which is given by each server device for the data stored in the data storage unit of each server device by the synchronization unit, from each server device and registering identification information for a server, which is the acquired identification information, and identification information for a client, which is transmitted to the client device as identification information of the data, in an identification information storage unit so as to match each other; and
a relay processing unit that performs relay processing of transmitting a request, which is sent to the server devices by the client device, to one of the plurality of server devices and transmitting a response, which is transmitted in response to the request by the server device that has received the request, to the client device,
wherein when the response includes the identification information for a server, the relay processing unit replaces the identification information for a server included in the response with the identification information for a client, which is stored in the identification information storage unit so as to be matched to the identification information for a server, and then transmits the response to the client device.

6. The relay device according to claim 5,
wherein when a new server device is made to operate while only one server device is operating, the synchronization unit performs data synchronization between the new server device and the server device in operation by acquiring the data, which is managed by the server device in operation, and identification information of the data from the server device in operation and transmitting the acquired data to the new server device, and
the identification information registration unit sets identification information of the data, which the synchronization unit has acquired from the server device in operation, as the identification information for a client of the data and registers the identification information for a client in the identification information storage unit so as to be matched to identification information for a server, which is the identification information of the data acquired by the synchronization unit, and also acquires the identification information, which is given by the new server device for the data that the synchronization unit has transmitted to the new server device, from the new server device and registers the acquired identification information in the identification information storage unit as identification information for a server corresponding to the new server device so as to be matched to the identification information for a server acquired by the synchronization unit.

7. A non-transitory computer readable medium causing a computer to function as a relay device which relays communication between each of a plurality of server devices, which manages data transmitted and received by a client device, and the client device, comprising:
synchronizing data in a data storage unit of each of the plurality of server devices by storing the data addressed to a user in the data storage unit of each of the plurality of server devices;
acquiring identification information, which is given by each server device for the data stored in the data storage unit of each server device by the synchronizing, from each server device and registering identification information for a server, which is the acquired identification information, and identification information for a client, which is transmitted to the client device as identification information of the data, in an identification information storage unit so as to match each other; and
relaying processing of transmitting a request, which is sent to the server devices by the client device, to one of the plurality of server devices and transmitting a response, which is transmitted in response to the request by the server device that has received the request, to the client device,
wherein when the response includes the identification information for a server, the relaying replaces the identification information for a server included in the response with the identification information for a client, which is stored in the identification information storage unit so as to be matched to the identification information for a server, and then transmits the response to the client device.
